(19) United States
(12) Patent Application Publication
(10) Pub. No.: US 2007/0295523 A1
(43) Pub. Date: Dec. 27, 2007

(54) PNEUMATIC HAMMER DRILL

(75) Inventors: CHUN-HAO CHEN, Taichung Hsien (TW); YUEH-PEI LIU, Taichung Hsien (TW)

Correspondence Address: FITZPATRICK CELLA HARPER & SCINTO, 30 ROCKEFELLER PLAZA, NEW YORK, NY, 10112, US

(73) Assignee: SHUN TAI PRECISON CO., LTD., Taichung Hsien (TW)

(21) Appl. No.: 11/552,325

(22) Filed: Oct. 24, 2006

(30) Foreign Application Priority Data
Jun. 23, 2006 (TW) 095211017

(51) Int. Cl. B23B 45/04

(52) U.S. Cl. 173/168; 173/128

(57) ABSTRACT

A pneumatic hammer drill includes a tool connected to a pneumatic cylinder having an air valve assembly, return- and forward-stroke chambers, a piston, and a connecting passage interconnecting fluidly the return- and forward-stroke chambers. When the piston approaches the tool, the connecting passage permits air to flow from the return- to the forward-stroke chamber so that the pressure in the return-stroke chamber is reduced, and the speed of a forward stroke of the piston is increased. When the piston approaches the air valve assembly, the connecting passage permits air to flow from the forward- to the return-stroke chamber so as to reduce the pressure in the forward-stroke chamber so that the piston moves close to the air valve assembly during a return stroke thereof and the length of the forward stroke is increased.

### CROSS-REFERENCE TO RELATED APPLICATION

This application claims priority of Taiwanese Application No. 095211017, filed on Jun. 23, 2006.

### BACKGROUND OF THE INVENTION

1. Field of the Invention

The invention relates to a pneumatic hand tool, more particularly to a pneumatic hammer drill.

2. Description of the Related Art

Referring to FIGS. 1 to 3, a conventional pneumatic hammer drill 1 includes a handle body 11, a pneumatic cylinder 12, a tool 13, and a limiting cover 18. The handle body 11 has an air inlet 111 and a cavity 112. The pneumatic cylinder 12 includes a cylindrical body 121 having inner and outer walls 125, 126, a rear end 120 fitted into the cavity 112, a front end 120′ opposite to the rear end 120, a forward-stroke chamber 16 proximate to the rear end 120, a return-stroke chamber 15 proximate to the front end 120′, a piston 132 slidable within the forward- and return-stroke chambers 16, 15, a plurality of vent holes 128 extending through the inner and outer walls 125, 126 and in fluid communication with the forward- and return-stroke chambers 16, 15, and two air passages 129 (only one is shown) each formed between the inner and outer walls 125, 126 and in fluid communication with the forward- and return-stroke chambers 16, 15.

The pneumatic cylinder 12 further includes an air valve assembly disposed at the rear end 120 thereof. The air valve assembly includes front and rear valve casings 122, 124, a limiting ring 127 sandwiched between the front and rear valve casings 122, 124, and a diaphragm 123 disposed within the limiting ring 127 and movable between a first position, where the diaphragm 123 abuts against the rear valve casing 124, as shown in FIG. 1, and a second position, where the diaphragm 123 abuts against the front valve casing 122, as shown in FIG. 3. The air valve assembly further includes a plurality of positioning pins 60 for connecting the front and rear valve casings 122, 124 and the limiting ring 127.

The tool 13 has a rear shank portion 131 extending into the return-stroke chamber 15, and an annular protrusion 133 formed proximate to the rear shank portion 131 and abutting against the front end 120′ of the cylindrical body 121.

The limiting cover 18 includes a ring 181 engaged to the outer wall 126 of the cylindrical body 121 at the front end 120′ thereof, and a cover member 182 sleeved on the ring 181 and cooperating with the front end 120′ to define a limiting space 19 for limiting movement of the annular protrusion 133 of the tool 13 therewithin.

When the diaphragm 123 is at the first position (see FIG. 1), highly compressed air introduced via the air inlet 111 enters the forward-stroke chamber 16 after passing through the diaphragm 123, and pushes the piston 132 forwardly to strike the rear shank portion 131 of the tool 13. The tool 13, in turn, produces a hammering force on a workpiece (not shown). However, as the piston 132 approaches the tool 13, some compressed air flows out of the forward-stroke chamber 16 via the vent holes 128, so that the pressure in the forward-stroke chamber 16 is reduced. At the same time, the pressure in the return-stroke chamber 15 is increased because the volume in the return-stroke chamber 15 is reduced. Hence, sliding movement of the piston 132 toward the tool 13 is slowed, resulting in the striking force of the piston 132 on the rear shank portion 131 of the tool 13 being weak and, ultimately, in an insufficient hammering force of the tool 13 on the workpiece.

When the diaphragm 123 is at the second position (see FIG. 3), the compressed air enters the return-stroke chamber 15 via the air passages 129, and pushes the piston 132 rearwardly toward the front valve casing 122. However, as the piston 132 approaches the front valve casing 122, some compressed air flows out of the return-stroke chamber 15 via the vent holes 128, so that the pressure in the return-stroke chamber 15 is reduced. Because the pressure in the forward-stroke chamber 16 is increased due to the reduction of the volume thereof as the piston 132 approaches the front valve casing 122, the piston 132 may fail to reach the front valve casing 122. This reduces the length of the forward stroke of the piston 132 to thereby similarly result in the hammering force of the tool 13 on the workpiece being insufficient.

### SUMMARY OF THE INVENTION

Therefore, the object of the present invention is to provide a pneumatic hammer drill that is capable of overcoming the aforementioned drawbacks of the prior art.

According to this invention, a pneumatic hammer drill comprises a handle body having an air inlet port, a tool, and a pneumatic cylinder. The pneumatic cylinder includes a cylindrical body and an air valve assembly. The cylindrical body has a rear end connected to the handle body, a front end connected to the tool, inner and outer walls extending from the rear end to the front end, a piston disposed within the inner wall and dividing the inner wall into a return-stroke chamber and a forward-stroke chamber, and at least one return channel that is disposed between the inner and outer walls, that is connected fluidly to the return-stroke chamber proximate to the front end, and that extends to the rear end. The air valve assembly is disposed at the rear end, and includes a diaphragm, and front and rear valve members confining a diaphragm cavity that receives the diaphragm. The front valve member is adjacent to the forward-stroke chamber, and has a front valve opening in spatial communication with the forward-stroke chamber and the diaphragm cavity. The rear valve member has at least one rear valve opening connected fluidly to the air inlet port and the diaphragm cavity. The diaphragm is movable between a first position, where the diaphragm abuts against the rear valve member, and a second position, where the diaphragm abuts against the front valve member. The diaphragm has at least one diaphragm hole fluidly connected to the diaphragm cavity. The pneumatic cylinder further has a return passage disposed in the air valve assembly and connected fluidly to the diaphragm cavity and the return channel, and a connecting passage proximate to the rear end of the cylindrical body and connected fluidly to the return channel for interconnecting fluidly the forward- and return-stroke chambers either in the first or second position of the diaphragm. When the piston approaches the tool, the connecting passage permits air to flow from the return- to the forward-stroke chamber so that the pressure in the return-stroke chamber is reduced and the speed of a forward stroke of the piston is increased. When the piston approaches the air valve assembly, the connecting passage permits air to flow from the forward- to the return-stroke chamber so as to reduce the pressure in the forward-stroke chamber so that the piston moves close to the air valve assembly during a return stroke thereof and the length of the forward stroke of the piston is increased.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a conventional pneumatic hammer drill;

FIG. 2 is an exploded perspective view of an air valve assembly of the conventional pneumatic hammer drill;

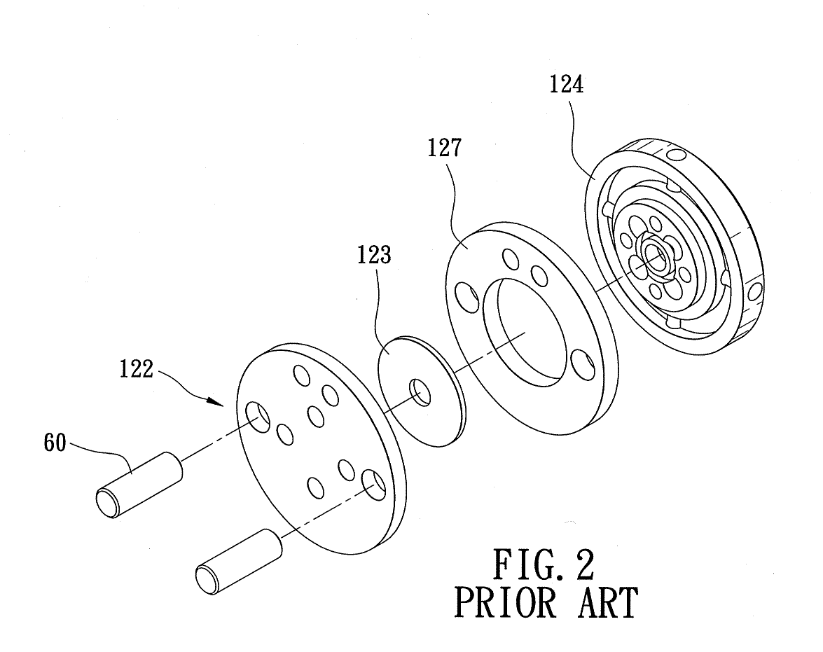

FIG. 3 is a view similar to FIG. 1, but with a diaphragm of the air valve assembly in another position;

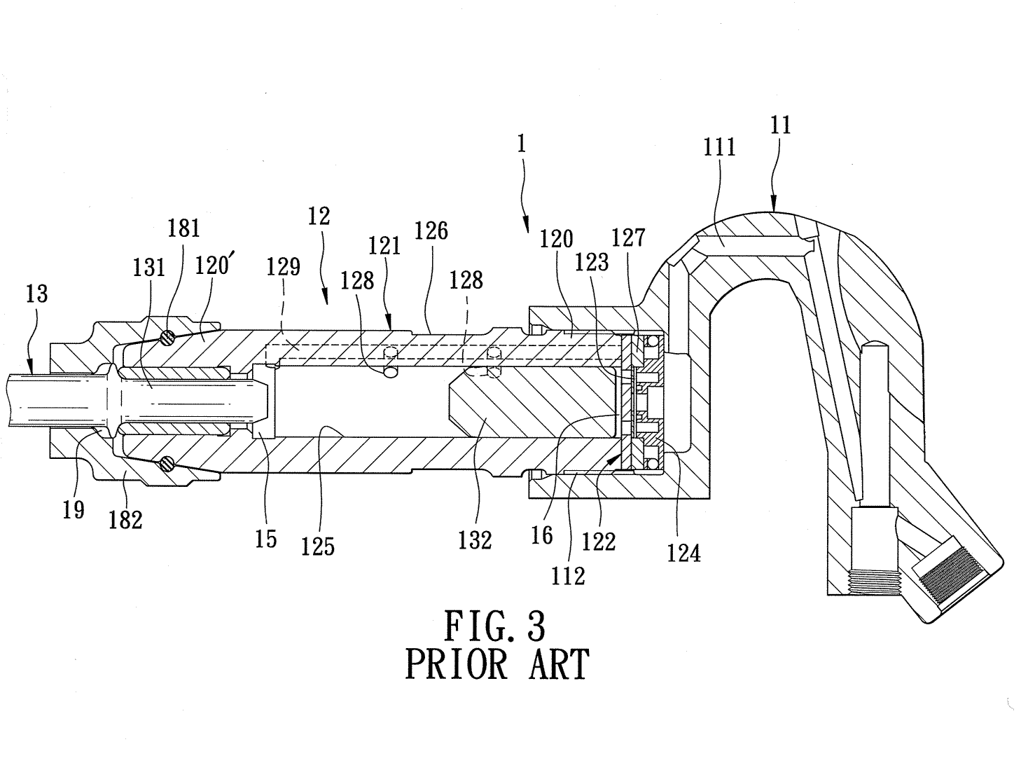

FIG. 4 is a sectional view of the first preferred embodiment of a pneumatic hammer drill according to the present invention;

FIG. 5 is an exploded perspective view of an air valve assembly of the first preferred embodiment;

FIG. 6 is an assembled sectional view of the air valve assembly of FIG. 5, illustrating a diaphragm at a first position;

FIG. 7 is a view similar to FIG. 6, but with the diaphragm at a second position;

FIG. 8 is a view similar to FIG. 4, but with a piston of the first preferred embodiment at a position reaching a front valve casing of the air valve assembly;

FIG. 9 is a sectional view of the second preferred embodiment of a pneumatic hammer drill according to the present invention; and

FIG. 10 is an exploded perspective view of an air valve assembly of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

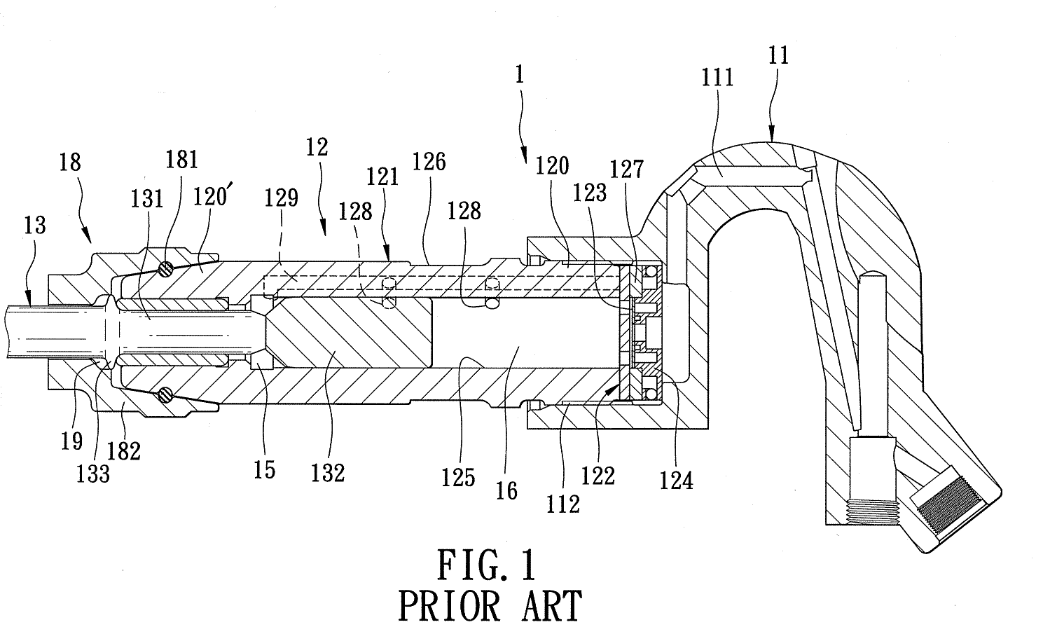

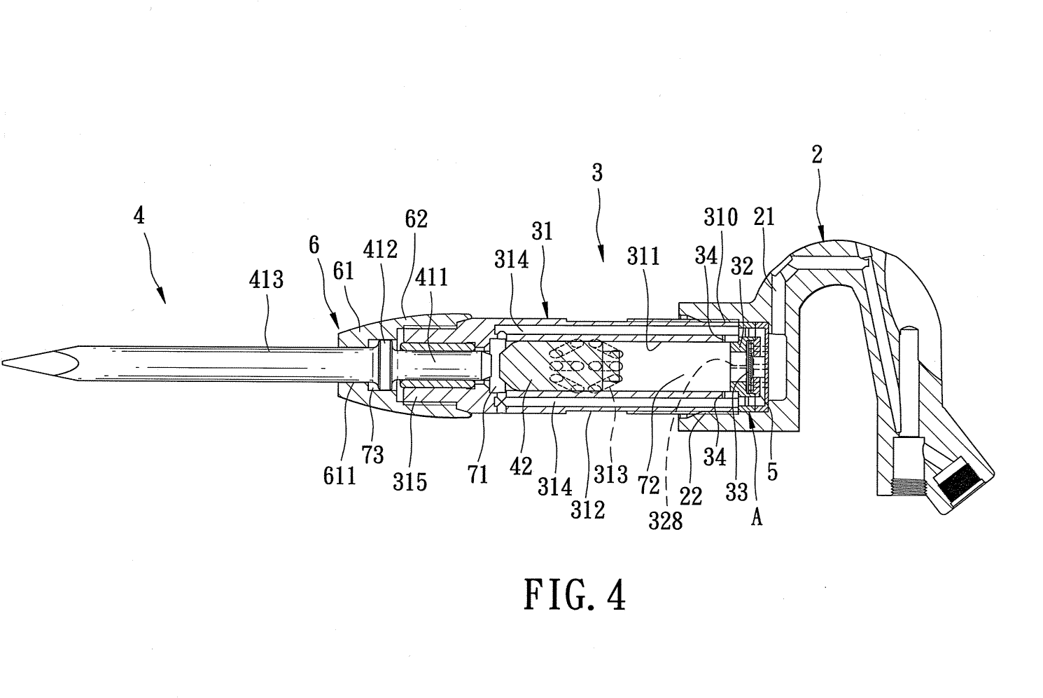

Referring to FIGS. 4 to 8, the first preferred embodiment of a pneumatic hammer drill according to the present invention is shown to comprise a handle body 2, a pneumatic cylinder 3, a tool 4, and a limiting cover 6. The handle body 2 is similar to that of the conventional pneumatic hammer drill 1 (see FIG. 1), and has an air inlet port 21 and a cavity 22.

The pneumatic cylinder 3 includes a cylindrical body 31, and an air valve assembly (A). The cylindrical body 31 has a rear end 310 fitted into the cavity 22, a front end 315 to connect with the tool 4, inner and outer walls 311, 312 extending from the front end 315 to the rear end 310, a piston 42 disposed within the inner wall 311 and dividing the inner wall 311 into a return-stroke chamber 71 that is proximate to the front end 315 and a forward-stroke chamber 72 that is proximate to the rear end 310, a plurality of vent holes 313 extending through the inner and outer walls 311, 312 and communicating fluidly with the forward- and return-stroke chambers 72, 71, and two return channels 314 each formed between the inner and outer walls 311, 312, connected fluidly to the return-stroke chamber 71, and extending to the rear end 310 of the cylindrical body 31.

The air valve assembly (A) is disposed at the rear end 310 of the cylindrical body 31, and includes a diaphragm 33, and front and rear valve members 32, 5 confining a diaphragm cavity 30 therebetween.

The front valve member 32 is adjacent to the forward-stroke chamber 72, and has a front side indented to form a front annular groove 324 that is substantially aligned with and connected to an annulus defined between the inner and outer walls 311, 312 of the cylindrical body 31, a rear side indented to form a rear annular groove 327, a partition wall 326 between the front and rear annular grooves 324, 327, a front valve opening 321 extending substantially centrally through the front valve member 32 and in spatial communication with the forward-stroke chamber 72 and the diaphragm cavity 30, an annular protrusion 325 projecting forwardly between the front valve opening 321 and the front annular groove 324 and extending into the rear end 310 of the cylindrical body 31, and an abutment face 320 at the rear side of the front valve member 32 and indented to form an annular recess 322 around the front valve opening 321. The annular recess 322 is spaced apart radially from the front valve opening 321.

The rear valve member 5 has a central slot 54 connected fluidly to the diaphragm cavity 30, an abutment face 53 extending around the central slot 54, and six angularly spaced-apart rear valve openings 51 disposed around the central slot 54 and connected fluidly to the air inlet port 21 and the diaphragm cavity 30.

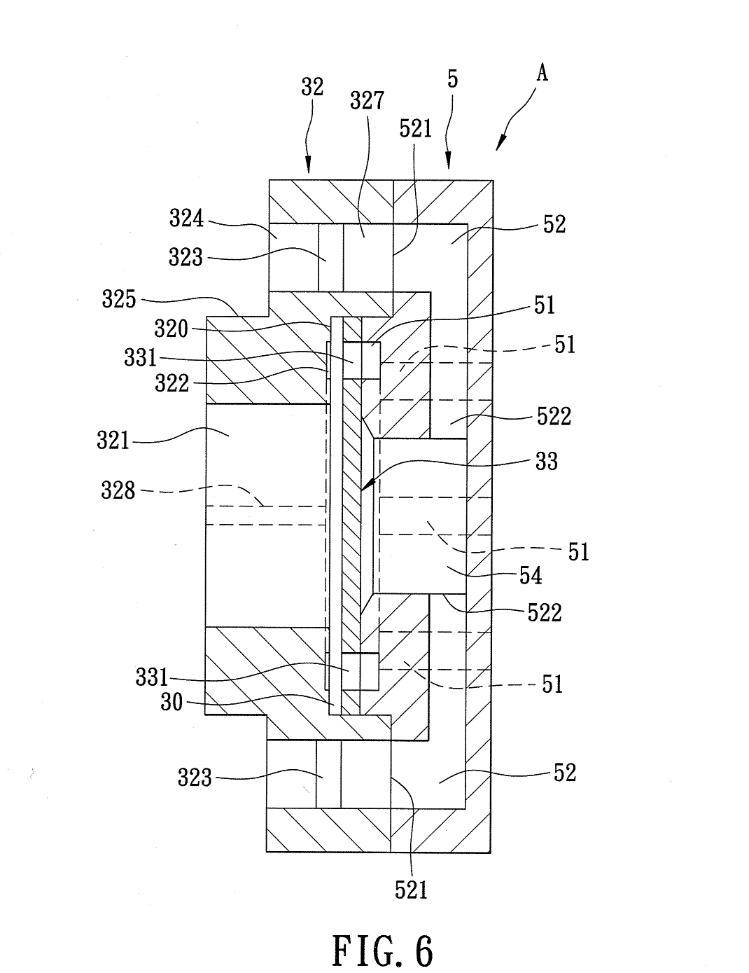

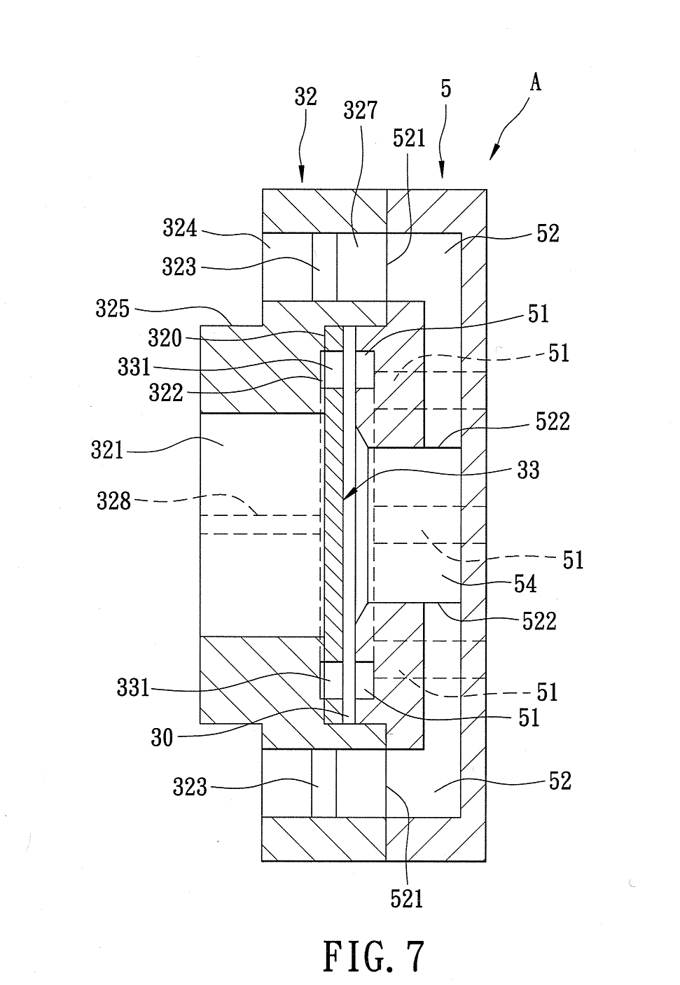

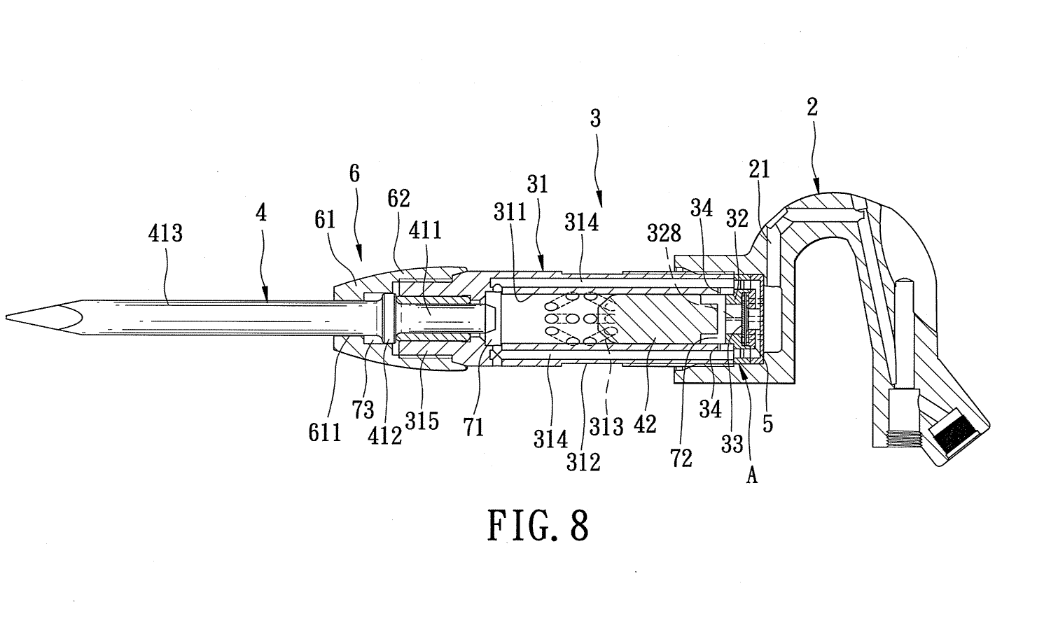

The diaphragm 33 is received in the diaphragm cavity 30, and is movable between first and second positions. At the first position, as shown in FIGS. 4 and 6, the diaphragm 33 abuts against the abutment face 53. At the second position, as shown in FIGS. 7 and 8, the diaphragm 33 abuts against the abutment face 320. The diaphragm 33 has six angularly spaced-apart diaphragm holes 331 that are formed proximate to a peripheral end thereof, that are staggered with the front valve opening 321, that are connected fluidly to the diaphragm cavity 30, and that are substantially aligned with the rear valve openings 51, respectively. The diaphragm holes 331 connect fluidly the front valve opening 321 to the rear valve openings 51 through the diaphragm cavity 30 when the diaphragm 33 is at the first position so as to permit air to flow into the forward-stroke chamber 72, and connect fluidly the return channels 314 to the rear valve openings 51 through the diaphragm cavity 30 and two return passages (which will be described hereinafter) when the diaphragm 33 is at the second position so as to permit air to flow into the return-stroke chamber 71.

The return passages are disposed in the air valve assembly (A), and are connected fluidly to the diaphragm cavity 30 and the return channels 314. The return passages include two diametrically opposed front through-bores 323 and two diametrically opposed rear through-bores 52. The front through-bores 323 are formed in the partition wall 326 of the front valve member 32, are in fluid communication with the front and rear annular grooves 324, 327, and are substantially aligned with the annulus defined between the inner and outer walls 311, 312 of the cylindrical body 31 and with the respective return channels 314. The rear through-bores 52 are formed in the rear valve member 5, and are connected fluidly to the respective front through-bores 323 and the diaphragm cavity 30 through the central slot 54. Each rear through-bore 52 has a first end 521 connected fluidly to the respective front through-bore 323, and a second end 522 connected fluidly to the central slot 54 which is connected fluidly to the diaphragm cavity 30. Each rear through-bore 52 extends radially and outwardly from the second end 522 of the respective rear through-bore 52, and turns forward to extend axially to the first end 521 of the corresponding rear through-bore 52. Each rear through-bore 52 cooperates with the respective front through-bore 323 and the front and rear annular grooves 324, 327 to form one of the return passages.

According to the present invention, at least one connecting passage is provided proximate to the rear end 310 of the cylindrical body 31, and is connected fluidly to one of the return channels 314 for interconnecting fluidly the forward-stroke and return-stroke chambers 72, 71 either in the first or second position of the diaphragm 33. In this embodiment, two first through holes 34 extending through the inner wall 311 are provided as two connecting passages, and are connected fluidly to the respective return channels 314 and the forward-stroke chamber 72. In addition, a second through hole 328 is formed as another connecting passage in the annular protrusion 325 of the front valve member 32 at a position offset from the front valve opening 321, and is connected fluidly to the forward-stroke chamber 72 and the diaphragm cavity 30. The second through hole 328 has opposite ends extending to the forward-stroke chamber 72 and the annular recess 322, respectively.

The tool 4 has a rear shank portion 411 extending into the return-stroke chamber 71 of the pneumatic cylinder 3 so as to allow the piston 42 to strike the rear shank portion 411, a front chisel portion 413 extending forwardly from the rear shank portion 411 and adapted to strike a workpiece (not shown), and an annular protrusion 412 formed proximate to the rear shank portion 411 and abutting against the front end 315 of the cylindrical body 31. The vent holes 313 are located at a central portion between the front valve member 32 and the rear shank portion 411.

The limiting cover 6 has a front end wall 61, and a skirt wall 62 extending rearwardly from the front end wall 61 and around the front end 315 of the cylindrical body 31. The front end wall 61 has an insert hole 611 for insertion of the rear shank portion 411 of the tool 4 therethrough. The skirt wall 62 has an internal thread that engages threadedly the cylindrical body 31 at the front end 315 thereof. The limiting cover 6 and the front end 315 of the cylindrical body 31 cooperatively define a limiting space 73 that is proximate to the insert hole 611. The annular protrusion 412 of the tool 4 limitedly moves to and fro within the limiting space 73.

Referring to FIGS. 4, 5, and 6, when the diaphragm 33 abuts against the rear valve member 5 at the first position, highly compressed air flows consecutively through the air inlet port 21, the rear valve openings 51, the diaphragm holes 331, the front valve opening 321, and enters the forward-stroke chamber 72 so as to push the piston 42 forwardly toward the tool 4. At this time, the central slot 54 and the rear through-bores 52 are disconnected fluidly from the diaphragm cavity 30. As the piston 42 approaches the rear shank portion 411, although the pressure in the forward-stroke chamber 72 is reduced because some compressed air will flow out of the forward-stroke chamber 72 via the vent holes 313, the first through holes 34 that permit the compressed air to flow from the return-stroke chamber 71 to the forward-stroke chamber 72 increase the pressure in the forward-stroke chamber 72 and reduce the pressure in the return-stroke chamber 71. Thus, the speed of a forward stroke and the striking force of the piston 42 are increased.

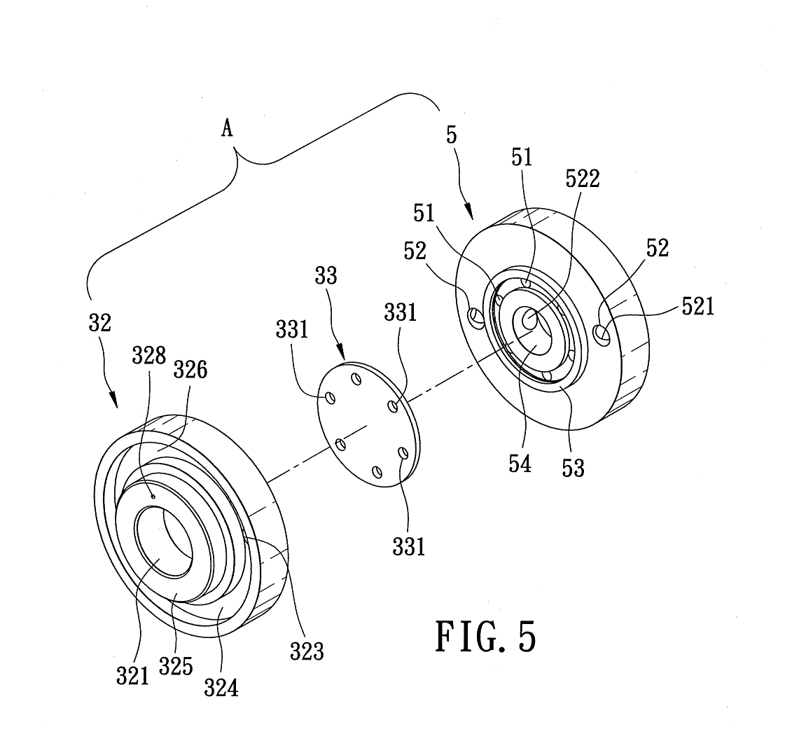

Referring to FIGS. 5, 7, and 8, when the diaphragm 33 abuts against the front valve member 32 at the second position, the front valve opening 321 is disconnected fluidly from the diaphragm cavity 30, but the rear valve openings 51 communicate fluidly with the return passages, i.e., the rear and front through-bores 52, 323 through the central slot 54 and the diaphragm cavity 30. With the diaphragm 33 at the second position, highly compressed air flows consecutively through the air inlet port 21, the rear valve openings 51, the central slot 54, the rear through-bores 52, the front through-bores 323, and the return channels 314, and enters the return-stroke chamber 71 so as to push the piston 42 rearwardly toward the front valve member 32. When the piston 42 approaches the front valve member 32, although some compressed air will flow out of the return-stroke chamber 71 via the vent holes 313, because the second through hole 328 communicates fluidly with the rear through-bores 52 via the annular recess 322, the diaphragm holes 331, the diaphragm cavity 30, and the central slot 54, the second through hole 328 permits the compressed air to flow from the forward-stroke chamber 72 to the return-stroke chamber 71 so as to reduce the pressure in the forward-stroke chamber 72. As such, the piston 42 can move close to the front valve member 32 during a return stroke thereof, thereby allowing the length of the forward stroke of the piston 42 to be increased.

As described above, the speed of the piston 42 can be faster during its forward stroke so that the striking force of the piston 42 on the tool 4 is increased compared to the piston 132 in the conventional pneumatic hammer drill 1 (see FIG. 1). Furthermore, due to the presence of the second through hole 328, the piston 42 can easily come in close proximity to the front valve member 32 during the return stroke thereof, thereby increasing the length of the forward stroke and the striking force of the piston 42.

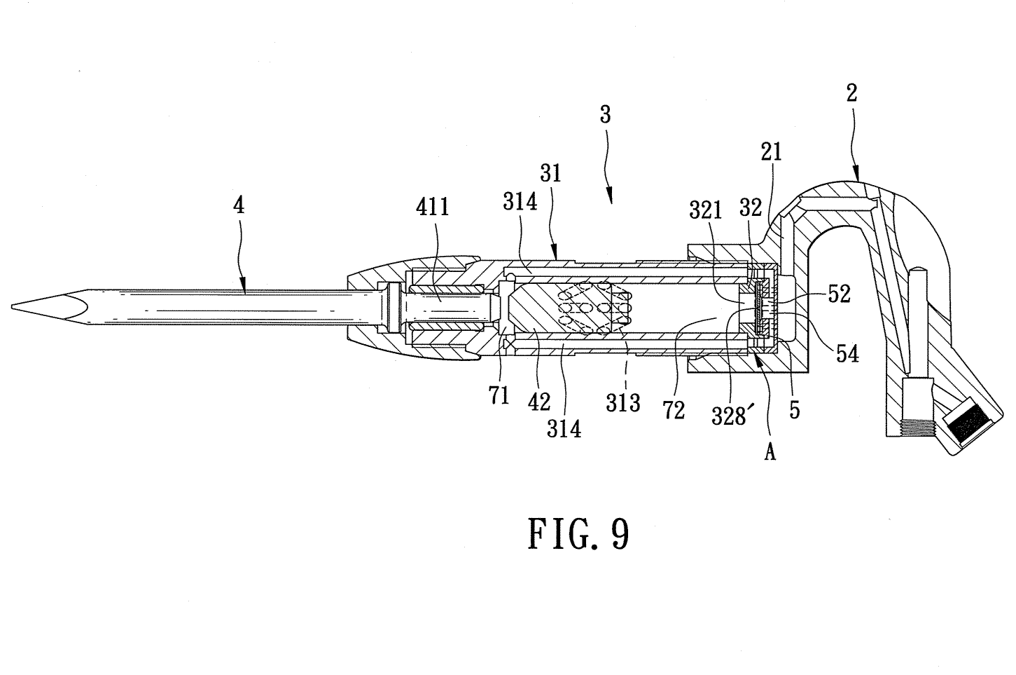

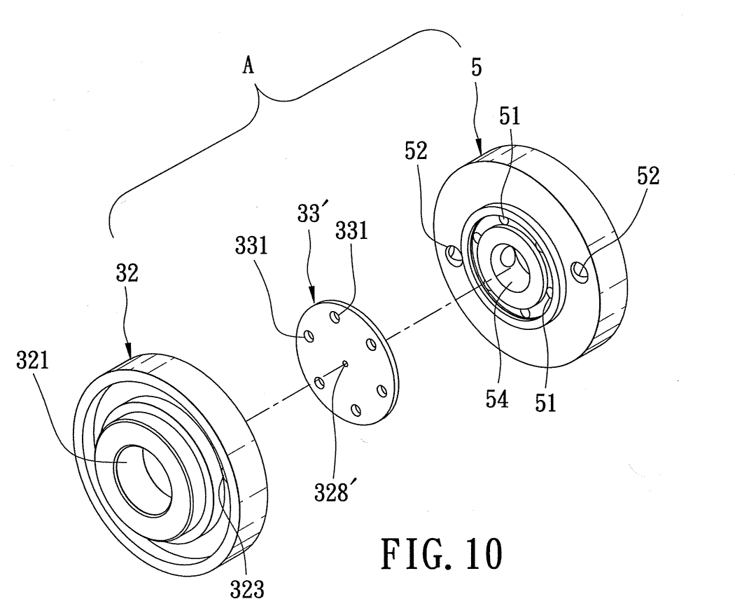

Referring to FIGS. 9 and 10, the second preferred embodiment of a pneumatic hammer drill according to the present invention is shown to be similar to the first preferred embodiment. However, in this embodiment, the connecting passage includes a third through hole 328′ formed substantially centrally in the diaphragm 33′. When the diaphragm 33′ abuts against the rear valve member 5 at the first position, highly compressed air flows consecutively through the air inlet port 21, the rear valve openings 51, the diaphragm holes 331, the front valve opening 321, and enters the forward-stroke chamber 72 so as to push the piston 42 forwardly toward the tool 4. When the diaphragm 33′ abuts against the front valve member 32 at the second position, the compressed air from the forward-stroke chamber 72 flows to the return-stroke chamber 71 through the front valve opening 21, the third through hole 328′, the central slot 54, the rear through-bores 52, the front through-bores 323, and the return channels 314. The advantages of the first preferred embodiment can be similarly attained using the second preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A pneumatic hammer drill comprising:
a handle body having an air inlet port;
a tool; and
a pneumatic cylinder including
a cylindrical body having a rear end connected to said handle body, a front end connected to said tool, inner and outer walls extending from said rear end to said front end, a piston disposed within said inner wall and dividing said inner wall into a return-stroke chamber and a forward-stroke chamber, and at least one return channel that is disposed between said inner and outer walls, that is connected fluidly to said return-stroke chamber proximate to said front end, and that extends to said rear end, and
an air valve assembly disposed at said rear end and including a diaphragm, and front and rear valve members confining a diaphragm cavity receiving said diaphragm;
said front valve member being adjacent to said forward-stroke chamber and having a front valve opening in spatial communication with said forward-stroke chamber and said diaphragm cavity;
said rear valve member having at least one rear valve opening connected fluidly to said air inlet port and said diaphragm cavity;
said diaphragm being movable between a first position, where said diaphragm abuts against said rear valve member, and a second position, where said diaphragm abuts against said front valve member, said diaphragm having at least one diaphragm hole fluidly connected to said diaphragm cavity;
said pneumatic cylinder further having a return passage disposed in said air valve assembly and connected fluidly to said diaphragm cavity and said return channel, and a connecting passage proximate to said rear end of said cylindrical body and connected fluidly to said return channel for interconnecting fluidly said forward-stroke and return-stroke chambers either in said first or second position of said diaphragm;
wherein, when said piston approaches said tool, said connecting passage permits air to flow from said return-stroke chamber to said forward-stroke chamber so that the pressure in said return-stroke chamber is reduced and the speed of a forward stroke of said piston is increased; and
wherein, when said piston approaches said air valve assembly, said connecting passage permits air to flow from said forward-stroke chamber to said return-stroke chamber so as to reduce the pressure in said forward-stroke chamber so that said piston moves close to said air valve assembly during a return stroke thereof and the length of the forward stroke of said piston is increased.

2. The pneumatic hammer drill of claim 1, wherein said connecting passage is formed in one of said inner wall, said front valve member, and said diaphragm.

3. The pneumatic hammer drill of claim 2, wherein said connecting passage includes a first through hole extending through said inner wall and connected fluidly to said return channel and said forward-stroke chamber.

4. The pneumatic hammer drill of claim 2, wherein said front valve opening extends substantially centrally through said front valve member, said connecting passage including a second through hole formed in said front valve member at a position offset from said front valve opening and connected fluidly to said forward-stroke chamber and said diaphragm cavity.

5. The pneumatic hammer drill of claim 2, wherein a plurality of said diaphragm holes are angularly spaced apart from each other in said diaphragm, said connecting passage including a third through hole formed substantially centrally in said diaphragm.

6. The pneumatic hammer drill of claim 4, wherein said front valve member further includes an abutment face for abutment with said diaphragm, said abutment face being indented to form an annular recess, said second through hole having opposite ends extending to said forward-stroke chamber and said annular recess, respectively.

7. The pneumatic hammer drill of claim 4, wherein said return passage includes a front through-bore formed in said front valve member and substantially aligned with an annulus defined between said inner and outer walls of said cylindrical body, and a rear through-bore formed in said rear valve member, said front through-bore being connected fluidly to said return channel, said rear through-bore being connected fluidly to said front through-bore and said diaphragm cavity.

8. The pneumatic hammer drill of claim 1, further comprising a limiting cover which has a front end wall and a skirt wall extending rearwardly from said front end wall and around said front end of said cylindrical body, said front end wall having an insert hole for insertion of said tool, said skirt wall having an internal thread that engages threadedly said cylindrical body.
